(19) United States
(12) Patent Application Publication
(10) Pub. No.: US 2020/0282808 A1
(43) Pub. Date: Sep. 10, 2020

(54) Unidirectional Heat Exchanger

(71) Applicants: DENSO International America, Inc., Southfield, MI (US); DENSO CORPORATION, Kariya-city (JP)

(72) Inventor: Rajeev SHARMA, Troy, MI (US)

(21) Appl. No.: 16/512,504

(22) Filed: Jul. 16, 2019

Related U.S. Application Data
(60) Provisional application No. 62/813,386, filed on Mar. 4, 2019.

(51) Int. Cl. B60H 1/32

(52) U.S. Cl. CPC B60H 1/3227; B60H 2001/3288; B60H 1/323; B60H 1/3228

(57) ABSTRACT

A heat exchange system including a first heat exchanger and a second heat exchanger arranged in parallel with the first heat exchanger with respect to flow of refrigerant through the heat exchange system. A flow control assembly is at an outlet of the first heat exchanger. The flow control assembly is configured to allow refrigerant to flow out of the first heat exchanger through the flow control assembly, and restrict refrigerant that has passed through the second heat exchanger from flowing through the flow control assembly and into the first heat exchanger.

### CROSS-REFERENCE TO RELATED APPLICATION

This application claims the benefit and priority of U.S. patent application No. 62/813,386 filed on Mar. 4, 2019, the entire disclosure of which is incorporated herein by reference.

### FIELD

The present disclosure relates to a heat exchanger including a flow control assembly that provides unidirectional refrigerant flow through the heat exchanger.

### BACKGROUND

This section provides background information related to the present disclosure, which is not necessarily prior art.

Existing heat exchangers allow refrigerant flow therethrough in both a first direction and a second direction that is opposite to the first direction. In typical heat pump systems, refrigerant has a tendency to flow to a relatively cooler area. Such refrigerant flow may disrupt the system, particularly if the system includes a cabin condenser and an exterior condenser. For example, during winter (or under other conditions when the exterior condenser is relatively cooler than the cabin condenser) refrigerant that has passed through the internal condenser may flow to an outlet of the exterior condenser and accumulate at the outlet of the exterior condenser. This refrigerant flow from the cabin condenser to the exterior condenser may disrupt refrigerant flow through the system, and may result in a reduction of refrigerant in the system.

### SUMMARY

This section provides a general summary of the disclosure, and is not a comprehensive disclosure of its full scope or all of its features.

The present disclosure is directed to a heat exchange system. The system includes a first heat exchanger, and a second heat exchanger arranged in parallel with the first heat exchanger with respect to flow of refrigerant through the heat exchange system. A flow control assembly is at an outlet of the first heat exchanger. The flow control assembly is configured to allow refrigerant to flow out of the first heat exchanger through the flow control assembly, and restrict refrigerant that has passed through the second heat exchanger from flowing through the flow control assembly and into the first heat exchanger.

The present disclosure further includes a heat exchange system for a vehicle. The heat exchange system includes an external heat exchanger configured to transfer heat between refrigerant and ambient air outside the vehicle. An internal heat exchanger is configured to transfer heat between refrigerant and air inside a passenger cabin of the vehicle. The internal heat exchanger is arranged in parallel with the external heat exchanger with respect to flow of refrigerant through the heat exchange system. A flow control assembly is at an outlet of the external heat exchanger. The flow control assembly is configured to allow refrigerant to flow out of the external heat exchanger through the flow control assembly, and restrict refrigerant that has passed through the internal heat exchanger from flowing through the flow control assembly and into the external heat exchanger. The flow control assembly includes a housing defining a passageway having an inlet at the outlet of the external heat exchanger and an outlet. An expansion valve is along a refrigerant line extending from the external heat exchanger and the internal heat exchanger to an evaporator. A compressor is along a refrigerant line extending from the evaporator to the external heat exchanger and the internal heat exchanger.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of select embodiments and not all possible implementations, and are not intended to limit the scope of the present disclosure.

FIG. 1 illustrates an exemplary heat pump system including an exemplary heat exchanger in accordance with the present disclosure;

FIG. 2A is a cross-sectional view of a flow control assembly of the heat exchanger in accordance with the present disclosure, the flow control assembly is in an open configuration;

FIG. 2B is a cross-sectional view of the flow control assembly in a closed configuration; and

FIG. 3 is an exploded view of components of the flow control assembly.

Corresponding reference numerals indicate corresponding parts throughout the several views of the drawings.

### DETAILED DESCRIPTION

Example embodiments will now be described more fully with reference to the accompanying drawings.

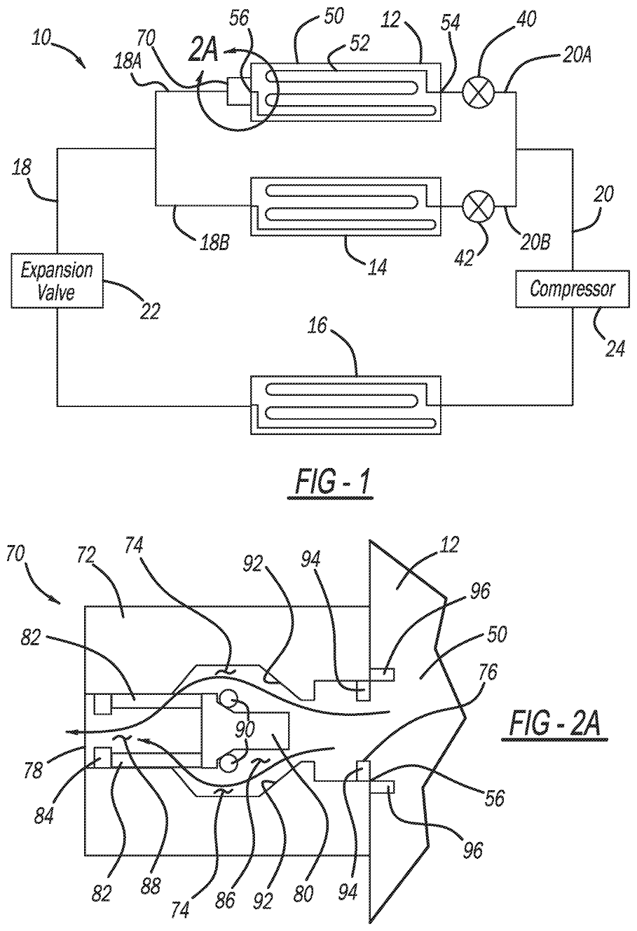

FIG. 1 illustrates an exemplary heat exchange system (such as a heat pump system) 10 in accordance with the present disclosure. The heat exchange system 10 generally includes a first heat exchanger 12 and a second heat exchanger 14. The heat exchange system 10 may be configured for use in a vehicle, with the first heat exchanger 12 configured to transfer heat between refrigerant of the system 10 and ambient air outside the vehicle. Thus the first heat exchanger 12 can be an external heat exchanger configured to be mounted at a location exposed to ambient air outside the vehicle. The second heat exchanger 14 can be an internal heat exchanger configured to transfer heat between refrigerant of the system 10 and air inside a passenger cabin of the vehicle. Thus the second heat exchanger 14 can be configured to be mounted at a location exposed to air of the passenger cabin of the vehicle. The first heat exchanger 12 and the second heat exchanger 14 may be any suitable heat exchangers, such as condensers.

The system 10 may further include an evaporator 16, which is in fluid communication with the first heat exchanger 12 and the second heat exchanger 14 by way of a refrigerant line 18. The refrigerant line 18 includes a first branch 18A connected to the first heat exchanger 12, and a second branch 18B connected to the second heat exchanger 14. Arranged along the refrigerant line 18 is an expansion valve 22.

The system 10 may also include a compressor 24. The compressor 24 is arranged along a refrigerant line 20 extending from the evaporator 16. The refrigerant line 20 includes a first branch 20A extending to the first heat exchanger 12, and a second branch 20B extending to the second heat exchanger 14. A first valve 40 is arranged along the first branch 20A for controlling flow of refrigerant to the first heat exchanger 12. A second valve 42 is arranged along the second branch 20B to control the flow of refrigerant to the second heat exchanger 14.

The first heat exchanger 12 includes a main body 50 having a plurality of refrigerant tubes 52 extending back and forth across the main body 50. Refrigerant flows into the refrigerant tubes 52 from the first branch 20A of refrigerant line 20 through an inlet 54. Refrigerant exits the refrigerant tubes 52 (and exits the main body 50) through an outlet 56 of the main body 50. Mounted to the main body 50 at the outlet 56 is a flow control assembly 70. Similar to the first heat exchanger 12, the second heat exchanger 14 also includes a plurality of refrigerant tubes extending therethrough, which are connected to an inlet at the second branch 20B and an outlet at the second branch 18B of the refrigerant lines 20 and 18 respectively.

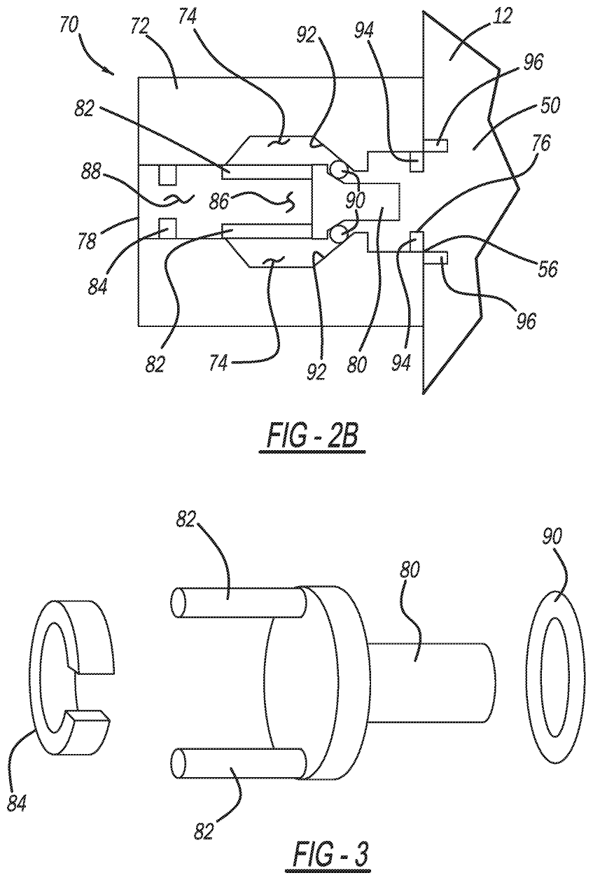

With additional reference to FIGS. 2A, 2B, and 3, the flow control assembly 70 of the first heat exchanger 12 will now be described in detail. The flow control assembly 70 includes a housing 72, which is secured to the main body 50 at the outlet 56 in any suitable manner, such as by heat staking. The housing 72 defines a refrigerant passageway 74 therethrough. The refrigerant passageway 74 has an inlet 76 and an outlet 78. The flow control assembly 70 is mounted such that the inlet 76 is at the outlet 56 of the main body 50 of the first heat exchanger 12.

Seated within the passageway 74 is a movable body 80. The movable body 80 may be made of any suitable polymeric material. The movable body 80 includes alignment members 82 extending from the moveable body 80 on a side of the movable body 80 facing the outlet 78. The alignment members 82 may be any suitable alignment members, such as a pair of posts 82. The movable body 80 has a maximum outer diameter that is smaller than the outlet 78 to allow the movable body 80 to be inserted through the outlet 78 into the refrigerant passageway 74. Between the inlet 76 and the outlet 78, at generally a mid-portion 86 of the passageway 74, the passageway 74 widens to allow refrigerant to flow around the movable body 80. To center the movable body 80 within the generally wider mid-portion 86 of the refrigerant passageway 74, the alignment members 82 abut opposing portions of the passageway 74 at a relatively narrow portion 88 of the passageway 74 extending between the outlet 78 and the wider mid-portion 86 of the passageway 74. To retain the movable body 80 within the passageway 74 (and specifically the relatively wider mid-portion 86), a stopper 84 is arranged between the posts 82 and the outlet 78. After the movable body 80 is seated in the passageway 74, the stopper 84 is inserted. The stopper 84 may be a c-clip as most clearly illustrated in FIG. 3, or any other suitable stopper.

The flow control assembly 70 further includes a seal 90, which is seated on the movable body 80 on a side of the movable body 80 opposite to the alignment members 82. The seal 90 may be any suitable seal, such as an annular polymeric seal. The seal 90 is arranged to abut a seal surface 92 of the passageway 74 when the movable body 80 is in a closed position (see FIG. 2B) to prevent refrigerant from flowing through the passageway 74 and into the first heat exchanger 12, as explained further herein.

With particular reference to FIGS. 2A and 2B, the flow control assembly 70 includes barriers 94 and/or 96. Barrier 94 is an annular barrier extending into the passageway 74 at the inlet 76. Barrier 96 is an annular barrier extending from the housing 72 into the outlet 56 of the first heat exchanger 12. The barriers 94 and 96 prevent brazing flux from entering the passageway 74 when the housing 72 is brazed onto the main body 50 of the first heat exchanger 12.

The movable body 80 is movable between an open position, which is illustrated in FIG. 2A, and a closed position, which is illustrated in FIG. 2B. The movable body 80 is moved to the open position of FIG. 2A by refrigerant exiting the first heat exchanger 12 when the force exerted on the movable body 80 by the refrigerant exiting the first heat exchanger 12 is greater than any force exerted on the movable body 80 by refrigerant flowing into the passageway 74 from the second heat exchanger 14 by way of the first branch 18A. The movable body 80 is moved to the closed position of FIG. 2B by refrigerant entering the passageway 74 from the second heat exchanger 14 (by way of the branches 18B and 18A) when force exerted on the movable body 80 by the refrigerant exiting the second heat exchanger 14 is greater than force exerted on the movable body 80 by refrigerant flowing into the passageway 74 from the first heat exchanger 12.

The flow control assembly 70 is particularly useful when the heat exchange system 10 is installed in a vehicle with the first heat exchanger 12 arranged as an external heat exchanger and the second heat exchanger 14 arranged as an internal heat exchanger. For example, when the external heat exchanger 12 is exposed to a relatively cooler environment as compared to the environment that the internal heat exchanger 14 is exposed to, refrigerant exiting the internal heat exchanger 14 will have a tendency to flow from the second refrigerant line branch 18B into the first refrigerant line branch 18A, and into the passageway 74 of the flow control assembly 70. Under such conditions, the refrigerant will contact the movable body 80 and force the movable body 80 towards the outlet 56 of the external heat exchanger 12 such that the seal 90 seals against the seal surface 92 to prevent refrigerant from the internal heat exchanger 14 from flowing into the external heat exchanger 12. The flow control assembly 70 thus restricts refrigerant flow through the heat exchanger 12 to only a single direction, which is from the inlet 54 to the outlet 56. This prevents any undesirable build-up of refrigerant at the outlet 56 of the external heat exchanger 12. One skilled in the art will appreciate that the flow control assembly 70 provides numerous additional advantages as well.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A heat exchange system comprising:
a first heat exchanger;
a second heat exchanger arranged in parallel with the first heat exchanger with respect to flow of refrigerant through the heat exchange system; and
a flow control assembly at an outlet of the first heat exchanger, the flow control assembly configured to allow refrigerant to flow out of the first heat exchanger through the flow control assembly, and restrict refrigerant that has passed through the second heat exchanger from flowing through the flow control assembly and into the first heat exchanger.

2. The heat exchange system of claim 1, further comprising an evaporator, a compressor, and an expansion valve.

3. The heat exchange system of claim 1, wherein:
the heat exchange system is configured for installation in a vehicle;
the first heat exchanger is an external heat exchanger configured to be mounted at a location exposed to ambient air about the vehicle; and
the second heat exchanger is an internal heat exchanger configured to be mounted at a location exposed to air of a passenger cabin of the vehicle.

4. The heat exchange system of claim 3, wherein the first heat exchanger is a first condenser, and the second heat exchanger is a second condenser.

5. The heat exchange system of claim 1, wherein the flow control assembly includes a housing defining a passageway having an inlet at the outlet of the first heat exchanger and an outlet.

6. The heat exchange system of claim 5, wherein:
the flow control assembly includes a movable body seated within the passageway;
the movable body is movable to an open position to allow refrigerant to flow out of the first heat exchanger through the flow control assembly; and
the movable body is movable to a closed position to restrict refrigerant that has passed through the second heat exchanger from flowing through the flow control assembly and into the first heat exchanger through the outlet of the first heat exchanger.

7. The heat exchange system of claim 6, wherein the movable body includes alignment members that abut an inner surface of the passageway to maintain the movable body centered within the passageway and allow refrigerant to flow around the movable body.

8. The heat exchange system of claim 7, wherein the movable body has a maximum outer diameter that is smaller than an outlet of the passageway to allow the movable body to be inserted into the passageway through the outlet; and
wherein the flow control assembly further includes a stopper seated in the passageway between the movable body and the outlet of the passageway to retain the movable body within the passageway.

9. The heat exchange system of claim 8, wherein the alignment members abut the stopper when the movable body is in the open position to retain the movable body within the passageway.

10. The heat exchange system of claim 6, further comprising a seal seated on the movable body, the seal contacts a seal surface within the passageway to form a fluid-tight seal when the movable body is in the closed position to prevent refrigerant from flowing through the passageway and into the first heat exchanger.

11. The heat exchange system of claim 6, wherein the movable body is moved to the open position by refrigerant exiting the first heat exchanger when force exerted on the movable body by the refrigerant exiting the first heat exchanger is greater than force exerted on the movable body by refrigerant flowing into the passageway from the second heat exchanger; and
wherein the movable body is moved to the closed position by refrigerant entering the passageway from the second heat exchanger when force exerted on the movable body by the refrigerant exiting the second heat exchanger is greater than force exerted on the movable body by refrigerant flowing into the passageway from the first heat exchanger.

12. The heat exchange system of claim 6, wherein the movable body is made of a polymeric material.

13. The heat exchange system of claim 1, wherein the flow control assembly is heat staked to the first heat exchanger.

14. The heat exchange system of claim 13, wherein the flow control assembly further includes at least one barrier at an interface between the flow control assembly and the outlet to restrict flux from flowing into a passageway defined by the flow control assembly when the flow control assembly is heat staked to the first heat exchanger.

15. A heat exchange system for a vehicle, the heat exchange system comprising:
an external heat exchanger configured to transfer heat between refrigerant and ambient air outside the vehicle;
an internal heat exchanger configured to transfer heat between refrigerant and air inside a passenger cabin of the vehicle, the internal heat exchanger is arranged in parallel with the first heat exchanger with respect to flow of refrigerant through the heat exchange system;
a flow control assembly at an outlet of the external heat exchanger, the flow control assembly configured to allow refrigerant to flow out of the external heat exchanger through the flow control assembly, and restrict refrigerant that has passed through the internal heat exchanger from flowing through the flow control assembly and into the external heat exchanger, the flow control assembly includes a housing defining a passageway having an inlet at the outlet of the external heat exchanger and an outlet;
an expansion valve along a refrigerant line extending from the external heat exchanger and the internal heat exchanger to an evaporator; and
a compressor along a refrigerant line extending from the evaporator to the external heat exchanger and the internal heat exchanger.

16. The heat exchange system claim 15, wherein:
the flow control assembly includes a movable body seated within the passageway;
the movable body is movable to an open position to allow refrigerant to flow out of the external heat exchanger through the flow control assembly; and
the movable body is movable to a closed position to restrict refrigerant that has passed through the internal heat exchanger from flowing through the flow control assembly and into the external heat exchanger through the outlet of the external heat exchanger.

17. The heat exchange system of claim 16, wherein the movable body is moved to the open position by refrigerant exiting the external heat exchanger when force exerted on the movable body by the refrigerant exiting the external heat exchanger is greater than force exerted on the movable body by refrigerant flowing into the passageway from the internal heat exchanger; and
wherein the movable body is moved to the closed position by refrigerant entering the passageway from the internal heat exchanger when force exerted on the movable body by the refrigerant exiting the internal heat exchanger is greater than force exerted on the movable body by refrigerant flowing into the passageway from the external heat exchanger.

18. The heat exchange system of claim 16, wherein:
the movable body includes alignment members that abut an inner surface of the passageway to maintain the movable body centered within the passageway and allow refrigerant to flow around the movable body;
the movable body has a maximum outer diameter that is smaller than an outlet of the passageway to allow the movable body to be inserted into the passageway through the outlet;
the flow control assembly further includes a stopper seated in the passageway between the movable body and the outlet of the passageway to retain the movable body within the passageway; and
the alignment members abut the stopper when the movable body is in the open position to retain the movable body within the passageway.

19. The heat exchange system of claim 15, wherein the flow control assembly is heat staked to the external heat exchanger.

20. The heat exchange system of claim 19, wherein the flow control assembly further includes at least one barrier at an interface between the flow control assembly and the outlet to restrict flux from flowing into a passageway defined by the flow control assembly when the flow control assembly is heat staked to the first heat exchanger.
